(19) United States
(12) Patent Application Publication
(10) Pub. No.: US 2026/0210514 A1
(43) Pub. Date: Jul. 23, 2026

(54) LIGHTING MODULE, LAMP DEVICE AND VEHICLE

(71) Applicant: VALEO VISION, Bobigny (FR)

(72) Inventors: Si CHEN, Bobigny (FR); Jiaye XU, Bobigny (FR); Heng ZHANG, Bobigny (FR); Lei FAN, Bobigny (FR)

(73) Assignee: VALEO VISION, Bobigny (FR)

(21) Appl. No.: 19/142,870

(22) PCT Filed: Dec. 22, 2023
(86) PCT No.: PCT/EP2023/087774

§ 371 Date: Jun. 24, 2025

(30) Foreign Application Priority Data
Dec. 27, 2022 (CN) 202211691319.4
Dec. 27, 2022 (CN) 202223506313.3

(51) Int. Cl. F21S 41/39; F21S 41/19; F21S 41/255; F21S 41/29; F21S 41/32; F21S 41/36; F21S 41/663; F21S 45/47; F21W 102/135

(52) U.S. Cl. CPC F21S 41/39; F21S 41/19; F21S 41/255; F21S 41/295; F21S 41/321; F21S 41/36; F21S 41/663; F21S 45/47; F21W 2102/135

(57) ABSTRACT

A lighting module, a lamp device and a vehicle are provided. The lighting module includes a first light source and a second light source, a light collector; and a first reflector and a second reflector, wherein the light collector includes a first light collection portion and a second light collection portion that are integrated into one part. The first light collection portion being configured to collect light from the first light source and guide the light towards the first reflector, the second light collection portion being configured to collect light from the second light source and guide the light towards the second reflector, the first reflector being configured to reflect light from the first light collection portion to form a first beam for emission, and the second reflector being configured to reflect light from the second light collection portion to form a second beam for emission.

### TECHNICAL FIELD

Embodiments of the present disclosure relate in general to the field of lighting and/or signaling, and in particular to a lighting module which can reduce manufacturing costs, and a lamp device and vehicle equipped with such a lighting module

### BACKGROUND OF THE INVENTION

Various lamp devices are known in various fields for providing light for lighting or signaling. For example, vehicle lamps are used in vehicles to provide lighting or signaling functions, in order to ensure safe driving or provide an ornamental function.

As an example, in vehicle applications, a light collector commonly used for low beams and a light collector for high beams are independent components and assembled separately, and, even in a lighting module having the dual functions of high and low beams, the low beam collector and the high beam collector are also independent components and assembled separately, wherein the material and manufacturing costs of independent components are high, high assembly accuracy is required, and additional connectors, wiring harnesses, circuit boards, installation components, etc. are needed, occupying additional assembly space in the vehicle lamp, which results in a large vehicle lamp volume.

### SUMMARY OF THE INVENTION

One purpose of the present disclosure is to solve or overcome at least one of the above and other problems and shortcomings in the prior art.

According to an aspect of the present disclosure, a lighting module is provided, comprising: a first light source and a second light source; light collector; as well as a first reflector and a second reflector, wherein the light collector comprises a first light collection portion and a second light collection portion that are integrated into one component, the first light collection portion being configured to collect light from the first light source and guide the light towards the first reflector, the second light collection portion being configured to collect light from the second light source and guide the light towards the second reflector, the first reflector being configured to reflect light from the first light collection portion to form a first beam for emission, the second reflector being configured to reflect light from the second light collection portion to form a second beam for emission.

In some embodiments, the first light collection portion and the second light collection portion are molded into one component, or are separate components and fixed to each other to be integrated into one component.

In some embodiments, the first light collection portion is configured to reflect light from the first light source towards the first reflector, and/or the second light collection portion is configured to reflect light from the second light source towards the second reflector.

In some embodiments, the first light collection portion comprises a reflector with a focal point at or near the first light source, and/or the second light collection portion comprises a reflector with a focal point at or near the second light source.

In some embodiments, the inner wall of the reflector of the first light collection portion defines a first reflective surface facing both the first light source and the first reflector, and/or, the inner wall of the reflector of the second light collection portion defines a second reflective surface facing both the second light source and the second reflector.

In some embodiments, the first light collection portion and the second light collection portion are spaced apart from each other to define a light outlet that allows the first and second beams to be emitted, and the light collector further comprises two side connection portions located on opposite sides of the light outlet, each side connection portion extending from the first light collection portion to the second light collection portion, so that the first light collection portion, the second light collection portion, and the side connection portion form an integrated component.

In some embodiments, the first reflector and the light collector are formed as different components, and the first reflector is configured to be fixedly mounted on the light collector.

In some embodiments, a slot is formed in each side connection portion, and the first reflector is at least partially inserted and fixed in the slot to reflect light from the first light collection portion into a first beam for emission from the light outlet.

In some embodiments, the first reflector comprises a plate-like reflective body and plug-in side portions located on opposite sides of the reflective body, the reflective body having a third reflective surface for reflecting light from the first light collection portion into a first beam to be emitted from the light outlet, the plug-in side portion being configured to be inserted and fixedly positioned in the slot.

In some embodiments, the reflective body is formed with a first cut-off line forming structure, which is configured to shape a portion of light from the first light collection portion to provide a first cut-off line in the first beam.

In some embodiments, the first cut-off line forming structure comprises a stepped structure defined by the edge of the third reflective surface.

In some embodiments, one end of the plug-in side portion abuts against a stop portion of the side connection portion that is located near the slot.

In some embodiments, the other end of the plug-in side portion is formed with a shoulder, and a retaining portion is provided on the side wall of the slot, the retaining portion being configured to press against the shoulder.

In some embodiments, the first light collection portion and the second light collection portion are located on opposite sides of the reflective body, the second reflector has a fourth reflective surface for reflecting light from the second light collection portion into a second beam to be emitted from the light outlet, and the fourth reflective surface is spaced apart from the reflective body and has one portion located on the same side as the first light collection portion of the reflective body and another portion located on the other side the same as the second light collection portion of the reflective body.

In some embodiments, one of the first and second beams is a low beam and the other thereof is a high beam.

In some embodiments, the lighting module further comprises a single circuit board, wherein one or more first light sources and one or more second light sources are mounted at intervals on the circuit board.

In some embodiments, the circuit board has a U-shaped contour defining an opening, the first and second light sources being respectively mounted on opposite sides of the opening having a U-shaped contour.

In some embodiments, the lighting module further comprises a circuit board for mounting the first light source and the second light source, and a single heat sink, wherein the circuit board and the light collector are mounted on the same side of the heat sink, so that the first light collection portion and the second light collection portion are located on the same side of the circuit board away from the heat sink.

In some embodiments, the heat sink comprises a heat dissipation plate and a plurality of heat dissipation fins extending from the heat dissipation plate, and a second reflector is formed on one side of the heat dissipation plate facing the circuit board.

In some embodiments, the second reflector comprises ribs partially protruding from the mounting surface.

In some embodiments, the lighting module further comprises a light projection component configured to project the first and second beams outwards into lighting beams for different lighting functions.

In some embodiments, the light projection component comprises a lens and a lens bracket, wherein the lens is mounted on the lens bracket to project the first and second beams outwards, and the lens bracket is mounted on the heat sink to cover the light collector, first reflector, second reflector, first light source, and second light source.

In some embodiments, at least one of the first reflector and the second reflector is formed with a cut-off line forming structure located within or near the focal plane of the lens.

According to another aspect of the present disclosure, an embodiment further provides a lamp device comprising a housing and a lighting module as described in any one of the embodiments disclosed herein, the lighting module being accommodated in the housing.

According to yet another aspect of the present disclosure, an embodiment further provides a vehicle comprising a lighting module or lamp device as described in any one of the embodiments disclosed herein.

A detailed description of the present disclosure is provided below by referring to the attached drawings to make other objectives and advantages of the present disclosure apparent and help achieve a comprehensive understanding of the present disclosure.

### BRIEF DESCRIPTION OF THE DRAWINGS

These and/or other aspects, features and advantages of the present disclosure will become apparent and readily understood from the following description of some illustrative embodiments in conjunction with the accompanying drawings. In the drawings:

FIG. 1 is a lateral perspective view schematically showing the structure of a lighting module according to an exemplary embodiment of the present disclosure;

FIG. 2 is a perspective view schematically showing the structure of a lighting module according to an exemplary embodiment of the present disclosure, with the lens and lens bracket removed;

FIG. 3 is a lateral view schematically showing the structure of a lighting module according to an exemplary embodiment of the present disclosure, with the lens and lens bracket removed;

FIG. 4 is a perspective view schematically showing the arrangement and structure of the power supply, circuit board, and heat sink of a lighting module according to an exemplary embodiment of the present disclosure;

FIG. 5 is a schematic exploded view showing the structure of a lighting module according to an exemplary embodiment of the present disclosure;

FIG. 6 is a front perspective view schematically showing the structure of a light collector of a lighting module according to an exemplary embodiment of the present disclosure;

FIG. 7 is a rear perspective view schematically showing the structure of a light collector of a lighting module according to an exemplary embodiment of the present disclosure;

FIG. 8 is a perspective view schematically showing the structure of a first cut-off line forming component of a lighting module according to an exemplary embodiment of the present disclosure;

FIG. 9 is a cross-sectional view schematically showing the structure of a lighting module according to an exemplary embodiment of the present disclosure, taken along line A-A in FIG. 2, with the lens and lens bracket removed;

FIG. 10 is a schematic diagram of the optical path of a lighting module according to an exemplary embodiment of the present disclosure; and

FIG. 11 is a schematic diagram of the optical path of a lighting module according to another exemplary embodiment of the present disclosure.

### DETAILED DESCRIPTION OF THE INVENTION

Embodiments of the present disclosure will be described in detail below in conjunction with the attached drawings. In this description, the same or similar components are indicated by the same or similar reference numerals. The following explanation of embodiments of the present disclosure with reference to the drawings is intended to explain the overall disclosed concept of the present disclosure, and should not be interpreted as a limitation of the present disclosure.

In addition, in the following detailed description, for ease of explanation, many specific details are given to provide a comprehensive understanding of the embodiments of the present disclosure. However, it is obvious that one or more embodiments may also be implemented without these specific details. In other cases, well-known structures and devices are shown in the form of illustrations to simplify the drawings.

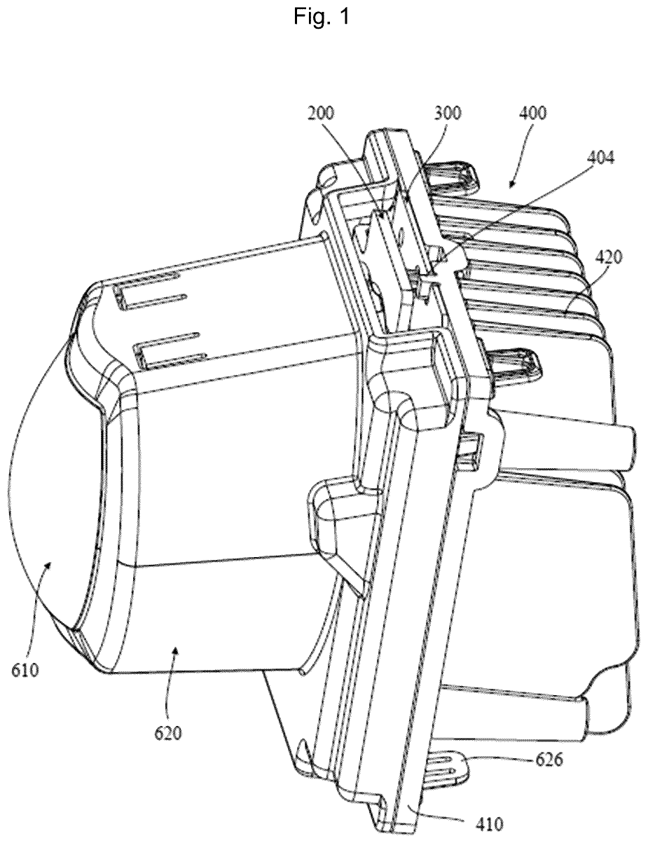

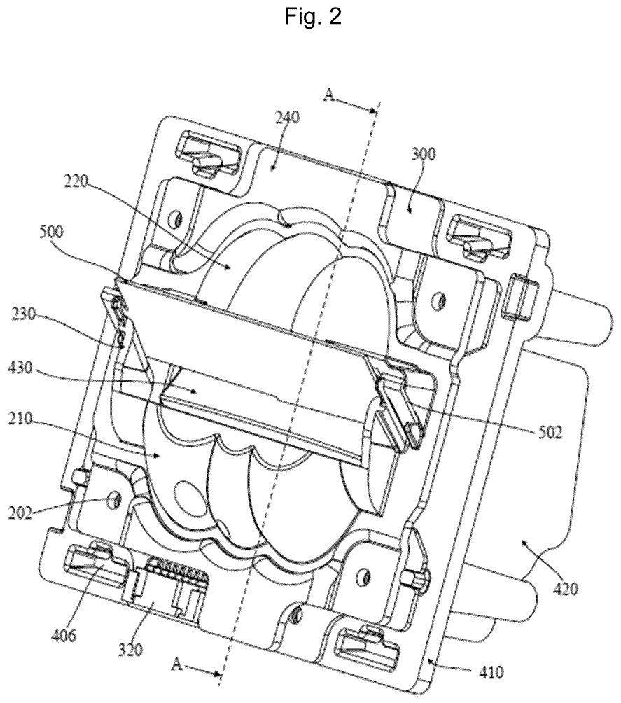

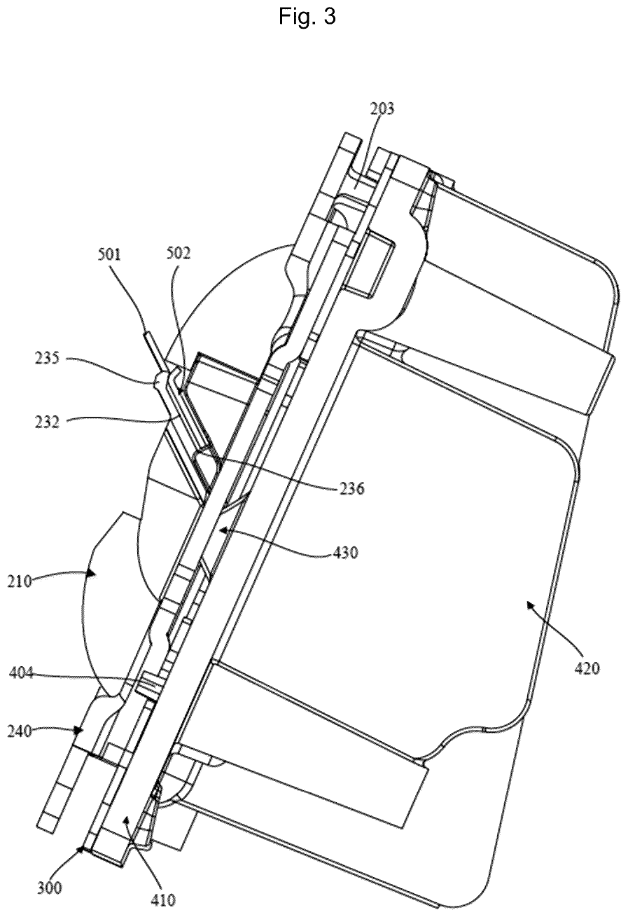

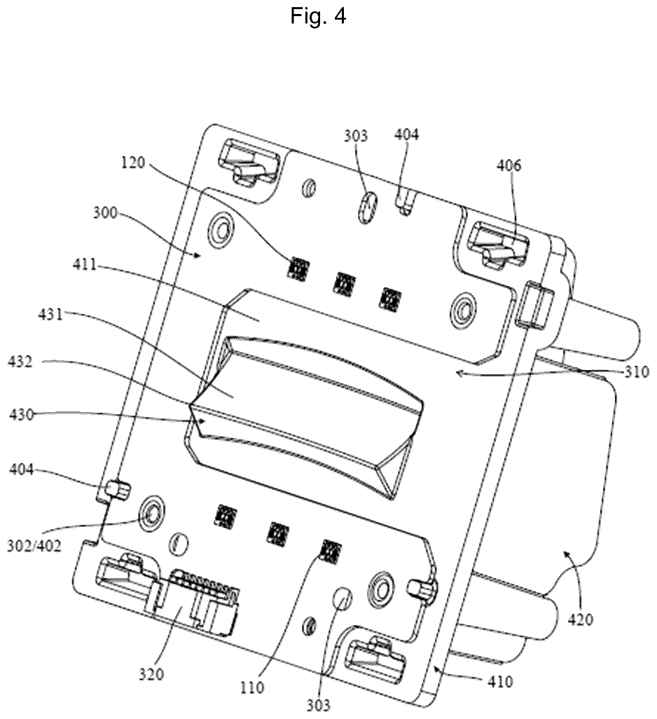

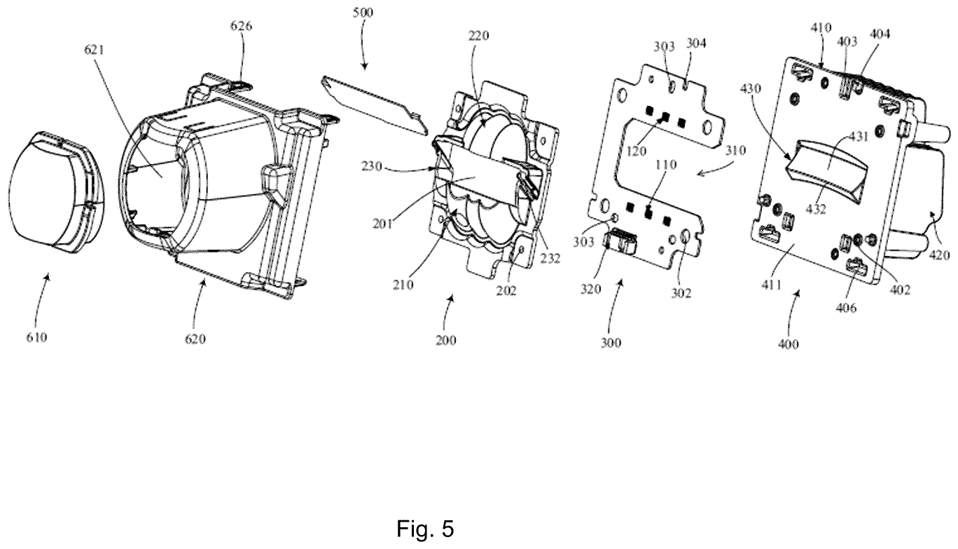

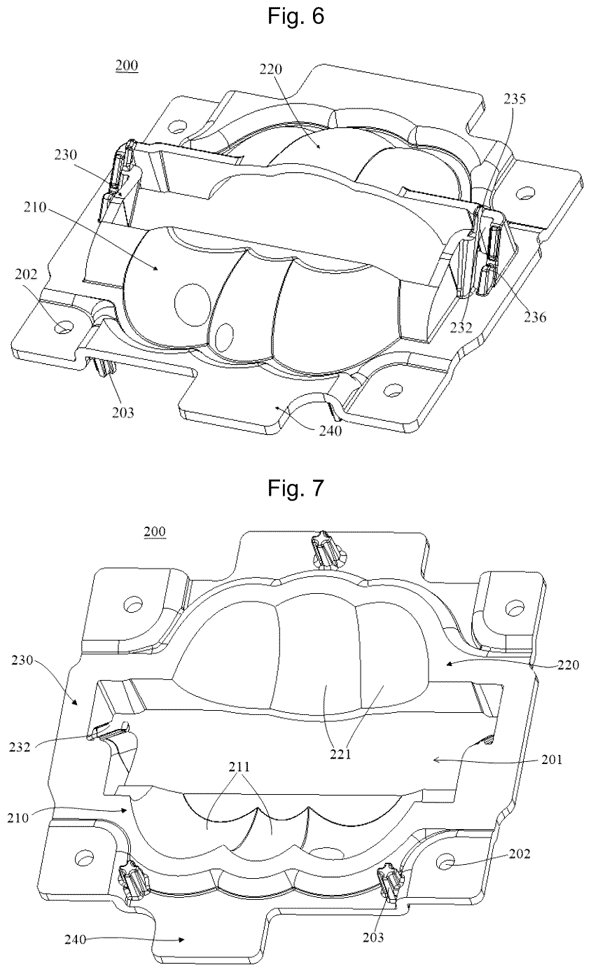

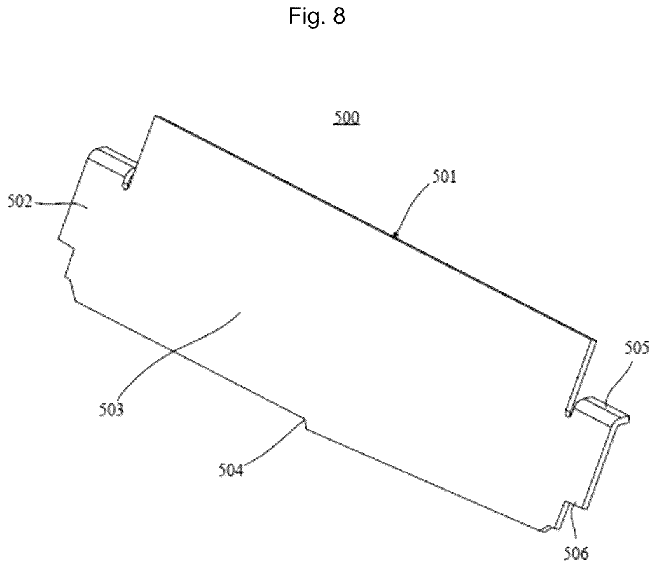

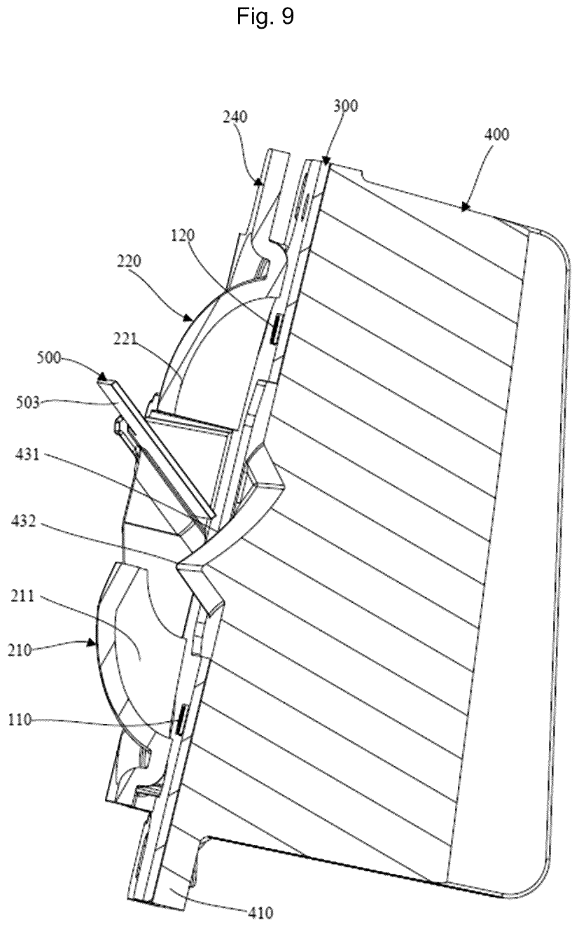

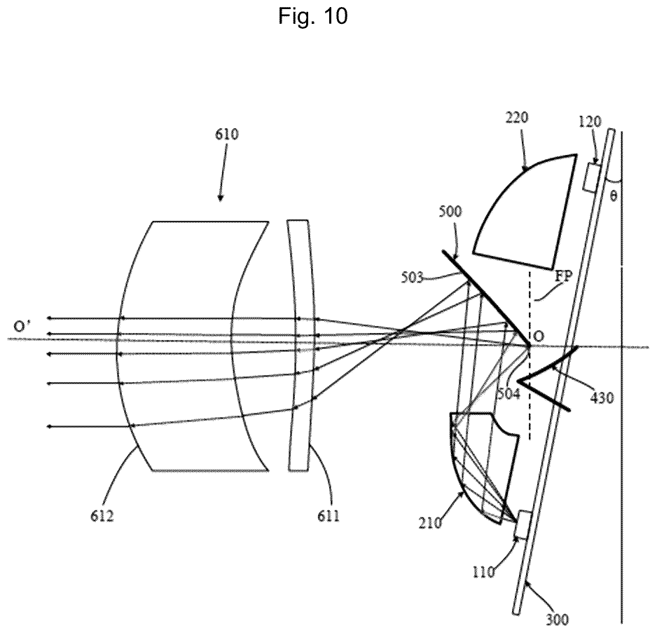

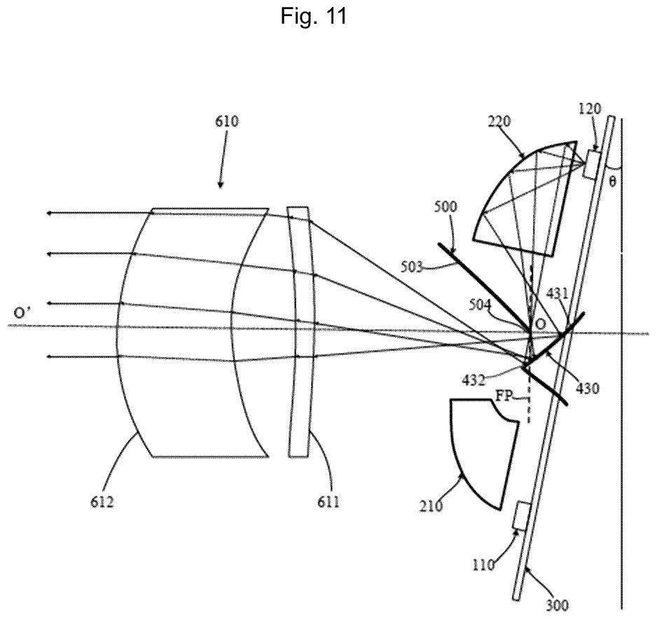

FIG. 1, FIG. 2, FIG. 3, FIG. 4, FIG. 5, FIG. 6, FIG. 7, FIG. 8, FIG. 9, FIG. 10, and FIG. 11 schematically show the structure of an lighting module according to an exemplary embodiment of the present disclosure, wherein the lighting module can function as a component of a lamp device, guiding light from a light source to be emitted with a desired illumination effect (for example, a desired intensity distribution or direction) to achieve lighting or signal indication functions. As an example, lamp devices may be mounted in vehicles as vehicle lamps, for example, including, but not limited to, headlights, such as dipped headlights and full beam headlights, for example, high and low beam integrated vehicle lamps, or vehicle lamps that provide other lighting functions. It will be understood that in addition to the lighting module, the lamp device may further comprise other components not shown, such as a housing for accommodating the lighting module, an optional light distribution screen, connectors, and installation/positioning elements. The term “vehicle” mentioned herein can refer to any type of vehicle, such as a motor vehicle, a motorcycle, or any other mobile machine capable of carrying at least one passenger or used for transporting people or goods.

In the embodiment shown, the lighting module mainly comprises a first light source 110, a second light source 120, an integrated light collector 200, a first reflector 500, and a second reflector 430. In an exemplary embodiment of the present disclosure, the first light source 110 and the second light source 120 may generate light for different lighting functions, such as a low beam function and a high beam function, and may comprise any suitable light-emitting devices, such as a halogen bulb, xenon lamp, LED, and laser, wherein, depending on actual needs, the lighting module may comprise one or more first light sources 110 and/or one or more second light sources 120 arranged in various forms. As an example, a single lighting module may be integrated with two different lighting functions or provide two different lighting beams.

A light source of the lighting module or lamp device may be arranged on a carrier. As an example, the lighting module may further comprise a circuit board 300, for example, a PCB, wherein the first light source 110 and the second light source 120 for providing different lighting functions may be mounted on the same circuit board 300.

Illustratively, the light collector 200 is configured to collect light from the first light source 110 and the second light source 120, and guide the light towards the corresponding first reflector 500 and second reflector 430, while the first reflector 500 and the second reflector 430 reflect the light from the light collector 200 towards a light projection component. In some examples, as described below, the first reflector or the second reflector may be formed with a cut-off line forming structure for forming a cut-off line in an outgoing beam from the lighting module.

In order to dissipate the heat of the lighting module (for example, a light source or another heating component thereof) in a timely manner and effectively, the lighting module may further comprise a heat sink 400. As an example, the heat sink 400 may comprise a heat dissipation plate 410 for heat conduction and a plurality of heat dissipation fins 420 extending from the heat dissipation plate 410, and the light collector 200 and the circuit board 300 carrying the first light source 110 and the second light source 120 may be mounted on a mounting surface 411 of the heat dissipation plate 410, for example, being fixed to the heat dissipation plate 410 by fasteners (not shown) respectively, so that the light collector 200, the first light source 110 and the second light source 120 are both located on the side of the circuit board 300 away from the heat sink 400.

In an embodiment of the present disclosure, the light collector 200 cooperates with the first reflector 500 and the second reflector 430 to shape the light from the first light source 110 and the second light source 120 into a beam with a desired lighting function (for example, a low beam or high beam function) for emission. The structures of a light collector and a reflector will be described in detail below with reference to the drawings.

Optionally, in some embodiments, the lighting module may further comprise a light projection component for receiving a beam from the first reflector 500 and/or the second reflector 430, and providing or projecting lighting beams with a desired lighting effect (for example, an intensity distribution or exit direction) towards, for example, the ground or the area in front of the vehicle, such as a low beam and a high beam, which may be a parallel, or approximately parallel, beam.

It will be understood that in the present disclosure, various forms of light projection components may be employed, including, but not limited to, various different arrangements of transmission components, reflectors, or light guides. In the embodiment shown, the light projection component comprises a lens 610, wherein the lens 610 may be mounted on the lens bracket 620, and the lens bracket 620 may also be mounted on the same heat sink 400. As a non-restrictive example, as shown in FIG. 10 and FIG. 11, the lens 610 may comprise a biconvex lens with two convex surfaces 611 and 612. In some examples, the optical axis of a light projection component (for example, the lens 610) may coincide with or be parallel to the optical axis O-O′ of the lighting module.

As an example, as shown in FIG. 1 and FIG. 5, the lens bracket 620 may have a frame-shaped structure, comprising a hollow housing, which defines a window 621 for receiving and mounting the lens 610 to allow beams formed by the light collector 200, first reflector 500, and second reflector 430 to propagate through the hollow housing and exit through the lens 620 at the same window. The lens bracket 620 may be formed or provided with a mounting foot 626 for being fixed to a jack 406 formed on the heat sink 400, for example, so that the lens bracket 620 covers the light collector 200, first reflector 500, second reflector 430, first light source 110, and second light source 120.

According to an embodiment of the present disclosure, the light collector 200 is an integrated or single component, comprising a first light collection portion 210 and a second light collection portion 220 that are integrated, wherein the first light collection portion 210 is configured and arranged to collect light from the first light source 110 and guide the light towards the first reflector 500, while the second light collection portion 220 is configured and arranged to collect light from the second light source 120 and guide the light towards the second reflector 430. Therefore, since the first and second light collection portions for providing different lighting functions are formed into an integrated component, which means that the two portions are integrated (for example, being moulded) into an integrated light collector, material and manufacturing costs may be reduced, assembly requirements may be relaxed, and space may be saved.

It will be understood that the terms “integral” and “integrated” are used herein relative to “independent” or “separate”, meaning that an integral or integrated component exists as a single entity and excludes any parts that are independent of or separate from each other in space, wherein, for example, various parts of an integral or integrated component may be simultaneously or separately formed (for example, being moulded) and subsequently assembled together to form a single component. Preferably, the first light collection portion 210 and the second light collection portion 220 are formed into one using the same material through a moulding process, in which case material and manufacturing costs may be reduced, assembly requirements may be lowered, and space may be saved. In another example, two light collection portions may be formed separately and then fixed together through buckles, threads, or other means, which can also save space.

The first reflector 500 is configured and arranged to reflect light from the first light collection portion 210 to form a first beam for emission (see FIG. 10), while the second reflector 430 is configured and arranged to reflect light from the second light collection portion 220 to form a second beam for emission (see FIG. 11).

In an exemplary embodiment, the light collector may shape and guide emergent light from a light source in a reflective manner, so at least one of the first light collection portion and the second light collection portion may comprise a reflector or mirror, or have a reflective surface, or a reflective coating or plating. Specifically, the first light collection portion 210 may reflect at least a portion of the light from the first light source 110 towards the first reflector 500, and the first reflector 500 may reflect the light from the first light collection portion 210 outwards in a desired or designed direction to form a first beam for a first lighting function. The second light collection portion 220 can reflect at least a portion of the light from the second light source 120 towards the second reflector 430, and the second reflector 430 can reflect the light from the second light collection portion 220 outwards in a desired or designed direction to form a second beam for a second lighting function.

As an example, one of the first and second beams is a low beam, and the other thereof is a high beam. However, the present disclosure is not limited thereto, and the first or second beam formed may be a beam used for other lighting functions, for example, a beam for functions including daytime driving light, parking light, fog light, and brake light. As an example, the combination of the first light collection portion 210 and the first reflector can, independently or together with the light projection component, provide a low beam, while the combination of the second light collection portion 220 and the second reflector 430 can, independently or together with the light projection component, provide a high beam. Depending on a specific application, the first and second light sources may be separately turned on to provide a low beam, a high beam, or a mixed or complementary beam formed by a combination of a low beam and a high beam through a single lighting module at different times. As an example of mixed or complementary beams, the low beam and high beam partially coincide or overlap when emitted.

In an exemplary embodiment, as shown in FIGS. 9-11, the first light collection portion 210 may have a first reflective surface 211 facing both the first light source 110 and the first reflector 500, and the second light collection portion 220 may have a second reflective surface 221 facing both the second light source 120 and the second reflector 430. Correspondingly, the first reflector 500 has a third reflective surface 503 for receiving and reflecting light from the first reflective surface 211, and the second reflector 430 has a fourth reflective surface 431 for receiving and reflecting light from the second reflective surface 221.

As an example, the first and second light collection portions may be made of materials with high heat resistance, for example, being moulded with glass or polymers, such as polycarbonate plastics (for example, PC-HT) or polyetherimide, and their reflective surfaces may be formed by metallising or applying a coating or plating on a surface of the formed light collection portion.

As an example, at least one of the first to fourth reflective surfaces may comprise one or more curved (such as elliptical, parabolic, or semi-elliptical) or flat reflective surfaces, wherein the curved reflective surface can shape light into a desired profile. As an example, a reflective surface of the light collection portion may be a surface obtained by rotation around an axis parallel to the optical axis of the lighting module, for example, a concave surface. For example, as shown in FIGS. 2, 3, 5-7, and 9-11, the first light collection portion 210 may comprise a reflector at least partially facing the corresponding first light source 110 and the first reflector 500, wherein the first light source 110 may be located at or near the focal point of the first light collection portion 210 or the reflector, so that the first light collection portion 210 or the reflector may reflect, in a substantially collimated manner, the light from the first light source 110 to the first reflector 500, thereby improving optical efficiency; similarly, the second light collection portion 220 may comprise a reflector at least partially facing the corresponding second light source 120 and the second reflector 430, wherein the second light source 120 may be located at or near the focal point of the second light collection portion 220 or the reflector, so that the second light collection portion 220 or the reflector may reflect, in a substantially collimated manner, the light from the second light source 120 to the second reflector, thereby improving optical efficiency. As shown in the figure, the first light collection portion 210 or the inner wall of the reflector defines the first reflective surface 211, and the second light collection portion 220 or the inner wall of the reflector defines the second reflective surface 221.

In an exemplary embodiment, as shown in FIGS. 2-3, 5-7, and 9-11, the first light collection portion 210 and the second light collection portion 220 are spaced apart from each other in the direction of intersection with (for example, being substantially perpendicular to or inclined relative to) the optical axis O-O′ of the lighting module (see FIGS. 10 and 11), to define therebetween a light outlet 201 that allows the first and second beams to be emitted separately or simultaneously. The light collector 200 may further comprise two side connection portions 230 located on opposite sides of the light outlet 201, each side connection portion 230 extending from the first light collection portion 210 to the second light collection portion 220, so that the first light collection portion 210, the second light collection portion 230, and the side connection portion 230 form an integrated component with a middle light outlet 201.

The third reflective surface 503 of the first reflector 500 and the fourth reflective surface 431 of the second reflector 430 are both partially exposed from the light outlet 201 to allow the reflected beam to exit from the light outlet 201. In the embodiment shown, a slot 232 is formed in each side connection portion 230, and the first reflector 500 is partially inserted and fixed in the slot 232. As an example, as shown in FIGS. 2, 3, and 5-9, the first reflector 500 comprises a plate-like reflective body 501 and plug-in side portions 502 located on opposite sides of the reflective body 501, wherein the reflective body 501 defines a third reflective surface 503 facing the first light collection portion 210, and the plug-in side portion 502 is configured to be inserted and fixedly positioned in the slot 232 of the side connection portion 230. As shown in FIGS. 2, 3, 6, and 8, one end 506 of the plug-in side portion 502 presses against a stop portion 236 located near the slot 232 of the side connection portion 230, while the opposite end of the plug-in side portion 502 is formed with a shoulder 505, wherein the side wall of the slot 232 is provided with a retaining portion 235, the retaining portion 235 being capable of pressing against the shoulder 505 to keep the plug-in side portion 502 in the slot 232.

In some embodiments, as shown in FIGS. 3 and 9-11, the first light collection portion 210 and the second light collection portion 220 may be located on opposite sides of the first reflector 500 or the reflective body 501 thereof, while a fourth reflective surface 431 of the second reflector 430 is spaced apart from the reflective body 501 and has a portion located on the same side as the first light collection portion 210 of the reflective body 501 and another portion located on the other side the same as the second light collection portion 220 of the reflective body 501, so that light from the second light collection portion 220 on the back side of the reflective body 501 may be reflected for emission through a gap (that is, a portion of the light outlet 201) between the reflective body 501 and the first light collection portion 210.

In some embodiments, as shown in FIGS. 2, 5, 8, 10, and 11, the reflective body 501 of the first reflector 500 may be formed with a first cut-off line forming structure 504, the first cut-off line forming structure 504 being configured to shape a portion of the light from the first light collection portion 210 to form or provide a first cut-off line, for example, a horizontal cut-off line, in the emitted first beam. As an example, the third reflective surface 503 of the reflective body 501 may be formed with a first cut-off line forming structure 504, for example, at a substantially horizontally extending edge (the lower edge in the figure), such as a raised or stepped edge with two horizontal flat parts, wherein light from the first light collection portion 210 but falling beyond the first cut-off line forming structure 504 will be absorbed or blocked by other components of the lighting module, without being emitted, so that a light and dark cut-off line is formed in the emitted first beam, for example, a stepped horizontal cut-off line or upper cut-off line that is low on the left and high on the right when viewed in a forward direction, thereby meeting relevant regulations and driving safety requirements. Similarly, the second reflector 430 may also be formed with a second cut-off line forming structure for providing a cut-off line in the emitted second beam, which, for example, is formed at the lower edge 432 of the fourth reflector 431 or defined by the edge 432.

In some examples, the first cut-off line forming structure 504 configured to form a cut-off line for a low beam may be located within or near the focal plane (FP) (as shown in FIGS. 10 and 11) of a light projection component (for example, the lens 610) to form a clear cut-off line in the low beam, while the remaining portion of the first reflective surface 503 of the first reflector 500 may be located downstream of the focal plane (FP) (that is, downstream of light propagation along the optical axis O-O′). In some examples, the second cut-off line forming structure configured to form a cut-off line for a high beam may be located near the focal plane (FP) of a light projection component (for example, the lens 610), for example, downstream near the focal plane (FP) or slightly off the focal plane (FP) in the direction of the optical axis, or located within the focal plane (FP), thereby forming a substantially clear cut-off line in the high beam, while the remaining majority of the fourth reflective surface 431 of the second reflector 430 may be located upstream of the focal plane (FP).

In an exemplary embodiment of the present disclosure, the lighting module integrated with two lighting functions may comprise only a single circuit board 300, with the first light source 110 and the second light source 120 mounted on the same circuit board 300 at intervals, thereby reducing the number of connectors and wiring harnesses used to connect two or more circuit boards to reduce the size and cost of the lighting module. As shown in FIGS. 5-7, the circuit board 300 may have a U-shaped contour defining an opening 310, with the first light source 110 and the second light source 120 mounted on both sides of the opening having a U-shaped contour, respectively. As shown in FIGS. 2, 4, and 5, only a single connector 320 is provided on the circuit board 300 to supply power/transmit signals to the circuit board.

In addition, a lighting module integrated with two lighting functions may also comprise only a single heat sink 400, a circuit board 300 with a first light source 110 and a second light source 120 mounted, and a light collector 200 mounted on the mounting surface 411 of the same heat sink 400, which allows a further reduction of the volume of the lighting module.

As shown in FIGS. 2-7, the light collector 200 may further comprise a mounting base 240 connected to the first light collection portion 210 and the second light collection portion 220, a mounting hole 202 is formed in the mounting base 240, a corresponding mounting hole 302 is formed in the circuit board 300, and a corresponding mounting hole 402 is formed in the heat sink 400, wherein the light collector 200 and the circuit board 300 may be mounted on the heat sink 400 by inserting fasteners (not shown) in the aligned mounting holes 202, 302, and 402. In some examples, a positioning hole 303 may further be formed on the circuit board 300, a positioning groove 403 may be formed at the edge of the mounting surface 411 of the heat dissipation plate 410, and a positioning column 203 may be formed on one side of the light collector 200 facing the circuit board 300, wherein the positioning column 203 is inserted into the aligned positioning hole 303 and positioning groove 403, so that the relative position among the light collector 200, the circuit board 300, and the heat sink 400 is fixed. In some other examples, a limit column 404 is formed at the edge of the mounting surface 411 of the heat dissipation plate 410, and a limit hole 304 is formed at the edge of the circuit board 300, wherein, after assembly, the limit column 404 is positioned in the limit hole 304 to prevent displacement of the circuit board 300 relative to the heat sink 400.

In some applications, according to the arrangement of the light collector and reflector and the direction in which light emission is guided, the lighting module may be slightly tilted inside the housing of the lamp device, wherein, for example, the mounting surface 411 of the heat sink 400 or the circuit board 300 may be tilted at an angle θ relative to the vertical direction or the focal plane (FP) of a light projection component (for example, a lens) (see FIGS. 10 and 11), so that light from a light source is guided by the light collector and reflector and projected from the light projection component to emit over an appropriate distance in front of the vehicle, rather than being projected downwards at an excessive tilt angle towards the road surface very close to the front of the vehicle, or projected upwards at an excessive tilt angle. The angle θ may be appropriately set according to actual applications, for example, within the range of 10° to 15°. Moreover, such a tilt makes it convenient to mount a light collector and a reflector.

In the embodiment shown, a second reflector 430 is formed on the side of the heat dissipation plate 400 facing the circuit board 300, which means that the second reflector 430 is formed as part of the heat dissipation plate 400, thereby allowing a reduction of the number of components of the lighting module to reduce assembly difficulty and improve compactness. As an example, as shown in FIGS. 2-5 and 9, the second reflector 430 may comprise or be formed as ribs partially protruding from the mounting surface 411 of the heat dissipation plate 400. However, the present disclosure is not limited thereto, and, in some other embodiments, according to actual applications, a second reflector may also be separately arranged, and the relative positions among the first reflector, the second reflector, and the light collector may be appropriately set, rather than being limited to the arrangement shown in the drawings, and for example, if the output window is sufficiently large, the second reflector may be located on the upper side of the first reflector.

Although the present disclosure has been described in conjunction with the accompanying drawings, the embodiments disclosed in the drawings are intended to illustrate preferred embodiments of the present disclosure and should not be construed as limiting the present disclosure. The dimensional proportions in the drawings are merely schematic, and must not be interpreted as a limitation of the present disclosure.

Although some embodiments of the general concept of the present disclosure have been shown and described, those ordinarily skilled in the art will understand that changes can be made to these embodiments without departing from the principle and spirit of the general concept of the present disclosure. The scope of the present disclosure is defined by the claims and their equivalents.

What is claimed is:

1. A lighting module comprising:
a first light source and a second light source;
a light collector; and
a first reflector and a second reflector, wherein
the light collector includes a first light collection portion and a second light collection portion that are integrated into one component,
the first light collection portion is configured to collect light from the first light source and guide the light towards the first reflector,
the second light collection portion is configured to collect light from the second light source and guide the light towards the second reflector,
the first reflector is configured to reflect light from the first light collection portion to form a first beam for emission, and
the second reflector is configured to reflect light from the second light collection portion to form a second beam for emission.

2. The lighting module according to claim 1, wherein the first light collection portion and the second light collection portion are moulded into one component, or the first light collection portion and the second light collection portion are separate components and are fixed to each other to be integrated into one component.

3. (canceled)

4. The lighting module according to claim 1, wherein
the first light collection portion includes a reflector with a focal point at or near the first light source, and/or
the second light collection portion includes a reflector with a focal point at or near the second light source.

5. The lighting module according to claim 1, wherein
the first light collection portion and the second light collection portion are spaced apart from each other to define a light outlet that allows the first and second beams to be emitted, and
the light collector includes two side connection portions located on opposite sides of the light outlet, each side connection portion extending from the first light collection portion to the second light collection portion, so that the first light collection portion, the second light collection portion, and the side connection portion form an integrated component.

6. The lighting module according to claim 5, wherein
the first reflector is configured to be fixedly mounted on the light collector.

7. The lighting module according to claim 6, wherein
a slot is formed in each side connection portion, and the first reflector is at least partially inserted and fixed in the slot to reflect light from the first light collection portion into a first beam for emission from the light outlet.

8. The lighting module according to claim 7, wherein
the first reflector includes a plate-like reflective body and plug-in side portions located on opposite sides of the reflective body,
the reflective body having a third reflective surface for reflecting light from the first light collection portion into a first beam to be emitted from the light outlet,
the plug-in side portion being configured to be inserted and fixedly positioned in the slot.

9. The lighting module according to claim 8, wherein the reflective body is formed with a first cut-off line forming structure, the first cut-off line forming structure being configured to shape a portion of light from the first light collection portion to provide a first cut-off line in the first beam.

10. The lighting module according to claim 9, wherein the first cut-off line forming structure includes a stepped structure defined by the edge of the third reflective surface

11. The lighting module according to claim 8, wherein one end of the plug-in side portion abuts against a stop portion of the side connection portion that is located near the slot.

12. The lighting module according to claim 11, wherein the other end of the plug-in side portion is formed with a shoulder, and a retaining portion is provided on the side wall of the slot, the retaining portion being configured to press against the shoulder.

13. The lighting module according to claim 8, wherein
the first light collection portion and the second light collection portion are located on opposite sides of the reflective body,
the second reflector has a fourth reflective surface for reflecting light from the second light collection portion into a second beam to be emitted from the light outlet, and
the fourth reflective surface is spaced apart from the reflective body and has one portion located on the same side of the reflective body as the first light collection portion and another portion located on the other side of the reflective body the same as the second light collection portion.

14. (canceled)

15. The lighting module according to claim 1, further comprising a single circuit board, wherein one or more first light sources and one or more second light sources are mounted at intervals on the circuit board.

16. The lighting module according to claim 15, wherein the circuit board has a U-shaped contour defining an opening, the first and second light sources being respectively mounted on opposite sides of the opening having a U-shaped contour.

17. The lighting module according to claim 1, further comprising a circuit board for mounting the first light source and the second light source, and a single heat sink, wherein the circuit board and the light collector are mounted on the same side of the heat sink, so that the first light collection portion and the second light collection portion are located on the same side of the circuit board away from the heat sink.

18. The lighting module according to claim 17, wherein the heat sink includes a heat dissipation plate and a plurality of heat dissipation fins extending from the heat dissipation plate, and a second reflector is formed on one side of the heat dissipation plate facing the circuit board.

19. The lighting module according to claim 18, wherein the second reflector includes ribs partially protruding from the mounting surface.

20. The lighting module according to claim 18, further comprises comprising a light projection component configured to project the first and second beams outwards into lighting beams for different lighting functions.

21. The lighting module according to claim 20, wherein the light projection component includes a lens and a lens bracket, wherein the lens is mounted on the lens bracket to project the first and second beams outwards, and the lens bracket is mounted on the heat sink to cover the light collector, first reflector, second reflector, first light source, and second light source.

22. The lighting module according to claim 21, wherein at least one of the first reflector and the second reflector is formed with a cut-off line forming structure located within or near the focal plane of the lens.

23. (canceled)

24. (canceled)
